(19) United States
(12) Patent Application Publication
(10) Pub. No.: US 2016/0136907 A1
(43) Pub. Date: May 19, 2016

(54) METHOD OF MOLDING PE-RT PIPELINE

(71) Applicant: Xiamen Runner Industrial Corporation, Xiamen (CN)

(72) Inventors: Zhi-Ming Li, Xiamen (CN); Hai-Gang Zhang, Xiamen (CN); Ju-Kun Que, Xiamen (CN); Ke-Quan Wu, Xiamen (CN); Ding-Yi Li, Xiamen (CN); Fang-Zhi Xiao, Xiamen (CN)

(21) Appl. No.: 14/938,283

(22) Filed: Nov. 11, 2015

(30) Foreign Application Priority Data
Nov. 17, 2014 (CN) 201410653219.1

(51) Int. Cl. B29D 23/00

(52) U.S. Cl. CPC B29D 23/001; B29D 23/003; B29K 2023/06; B29K 2995/0016

(57) ABSTRACT

A method of molding PE-RT pipeline includes processes of: extrusion molding a PE-RT pipe; and injection molding a connector of the PE-RT pipe. Wherein, the process of performing extrusion molding of the PE-RT pipe is similar to an ordinary pipe extrusion molding process. The process of performing injection molding of the connector for the PE-RT pipe includes following steps: positioning, to put the PE-RT pipe around and through the core of a rotation device on a rotation disk; using the rotation device to bring the PE-RT pipe to a hot air device, to melt the connector region to a highly elastic state; bringing the PE-RT pipe into rotation to perform injection molding for the connector region of the connector; and popping out, using the rotation device to bring the PE-RT pipe into rotation counterclockwise to a pop-out device, to pop out a PE-RT pipeline.

### BACKGROUND OF THE INVENTION

1. Field of the Invention

The present invention relates to a method of molding a pipeline, and in particular to a method of molding a PE-RT (polyethylene of raised temperature resistance) pipeline.

2. The Prior Arts

Presently, the connection of plastic pieces can be achieved through welding, screw thread connection, and secondary encapsulation, to realize the connection between various parts of plastic pieces. However, the disadvantages of these ways of connections are that, its precision is insufficient, its outer appearance is inferior, the production cost is high, while the connection strength is not strong enough. In addition, when the plastic piece thus connected is subject to high temperature or impact, the connected portions between the plastic pieces tend to have cracks, and water leakages, etc., as such its applications are rather limited.

Therefore, presently, the design and performance of plastic pieces connection is not quite satisfactory, and it leaves much space for improvement.

### SUMMARY OF THE INVENTION

In view of the problems and drawbacks of the prior art, the present invention provides a method of molding PE-RT pipeline, to overcome the shortcomings of the prior art.

A major objective of the present invention is to provide a method of molding PE-RT pipeline, comprising the processes of: extrusion molding a PE-RT pipe; and injection molding a connector of the PE-RT pipe. Wherein, the extrusion molding process includes the following steps: preparing the material →using an extruder and the material to extrude into mold a PE-RT pipe →performing vacuum diameter fixing →drawing and transporting →cutting the PE-RT pipe into predetermined size to enter a positioning region.

The injection molding process includes the following steps: positioning: to put the PE-RT pipe around and through the core of a rotation device on a rotation disk →using the rotation device rotating conterclockwise to bring the PE-RT pipe into a hot air device, to melt the connector region of the PE-RT pipe to a highly elastic state →performing injection molding to form the connector, using the rotation device to bring the PE-RT pipe into rotation counterclockwise to an injection mold, then close the mold, to perform injection molding for the connector in the connector region →popping out: open the mold and use the rotation device to bring the PE-RT pipe into rotation counterclockwise to a pop out device, to pop out the PE-RT pipeline.

According to an aspect of the present invention, the extrusion speed of the extruder is 1-10 mm/s. After a connector region is melted, start injection molding for the connector region to form a connector within 2 seconds. The period of injection molding for the connector is 15-40 seconds, while entire period for molding the PE-RT pipeline is 18-50 seconds.

According to another aspect of the present invention, the connector regions are at both ends of the PE-RT pipe, while the length of the connector region is 10 mm-50 mm.

According to yet another aspect of the present invention, the hot air temperature of the hot air device is controlled at 200° C. -400° C.

According to further aspect of the present invention, both the flux and the temperature of an air flow produced by the hot air device can be adjusted.

Compared with the prior art, the present invention has the following advantages: (1) In the present invention, hot air preheating is performed for the connector region (namely, the encapsulation region) of the PE-RT pipe, so that the surface of that region is melted to a highly elastic state, then perform injection molding for the connector of the plastic piece, to raise the adhesion between the plastic pieces, thus increasing the strength of the entire plastic piece after encapsulation. (2) The present invention utilizes automatic production technology, to realize the integrated production of extrusion molding and injection molding for the PE-RT pipe and connector and connecting them together into a PE-RT pipeline through using the rotation device, hot air device, and the pop out device. As such, it can raise production efficiency, reduce production cost, solve the problem of over inventory, and expedite order processing. (3) It can realize the encapsulation and connection of plastic piece connector of various lengths, through varying the extruder and various molds, to increase production flexibility, and widen its scope of application.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1(a) is a flowchart of the steps of a method of molding the PE-RT pipeline according to an embodiment of the present invention;

FIG. 1(b) is a flowchart of the steps contained in the process of extrusion molding a PE-RT pipe according to an embodiment of the present invention; and

FIG. 1(c) is a flowchart of the steps contained in the process of injection molding a connector of the PE-RT pipe according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

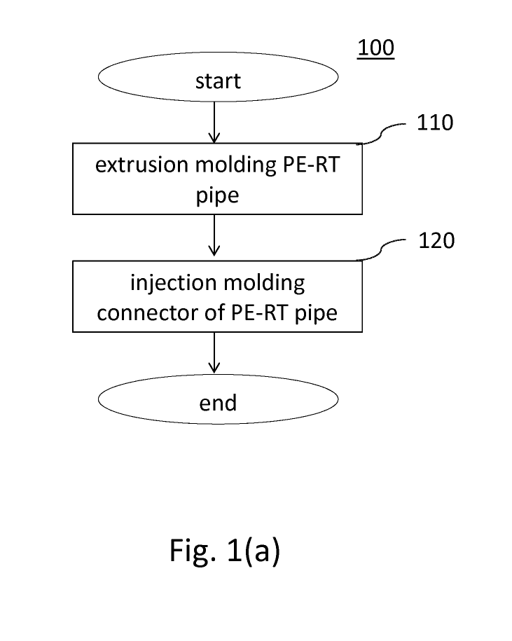

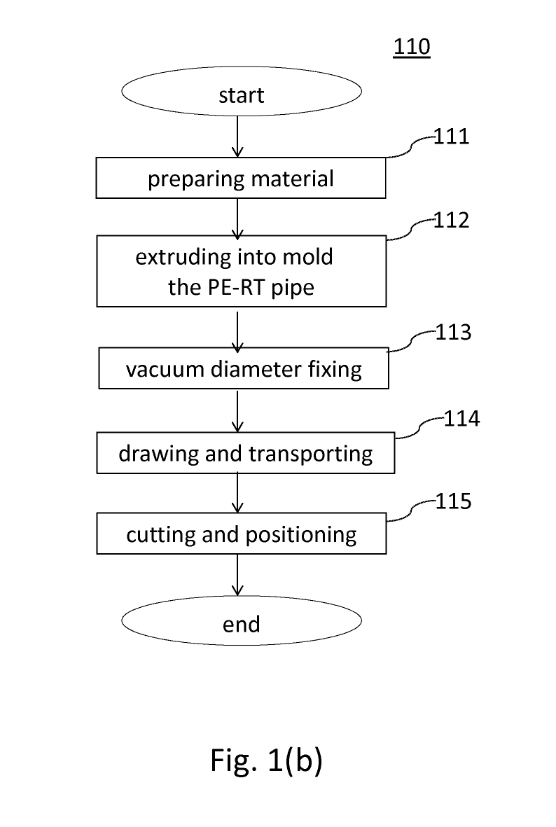

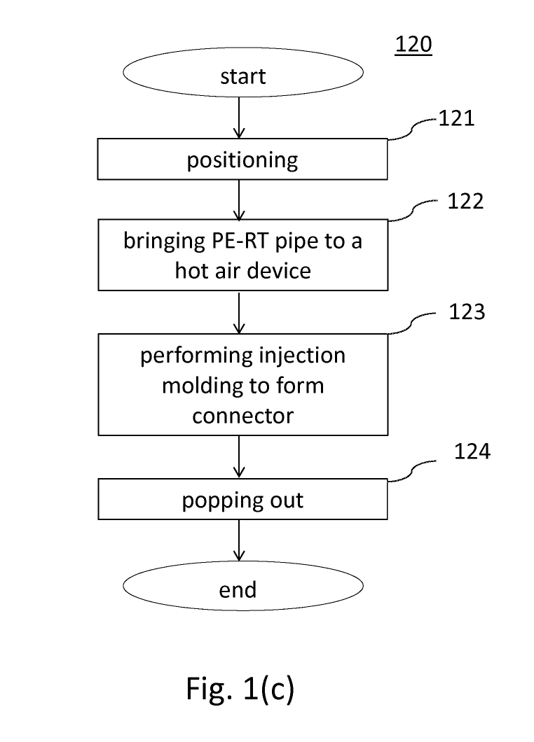

Refer to FIGS. 1(a) to 1(c) respectively for a flowchart of the steps of a method of molding the PE-RT pipeline according to an embodiment of the present invention; a flowchart of the steps contained in the process of extrusion molding a PE-RT pipe according to an embodiment of the present invention; and a flowchart of the steps contained in the process of injection molding a connector of the PE-RT pipe according to an embodiment of the present invention.

Firstly, as shown in FIG. 1, the present invention provides a method of molding a PE-RT pipeline 100 (the PE-RT pipeline is the abbreviation of Polyethylene of Raised Temperature Resistance Pipeline, a heat resistant Polyethylene pipeline, and that is also referred to as a Non Cross-Linked Polyethylene pipeline used for hot water) including the processes of: extrusion molding a PE-RT pipe (step 110), and injection molding a connector of the PE-RT pipe (step 120), to form a PE-RT pipeline.

Next, as shown in FIG. 1(b), the process of extrusion molding a PE-RT pipe (step 110) includes the following steps: preparing the material (step 111) →using an extruder and the material to extrude into mold a PE-RT pipe (step 112) →performing vacuum diameter fixing (step 113) →drawing and transporting (step 114) →cutting the PE-RT pipe into predetermined size to enter a positioning region (step 115).

Then, as shown in FIG. 1(c), the process of injection molding a connector of the PE-RT pipe (step 120) includes the following steps: positioning: to put the PE-RT pipe around and through the core of a rotation device on a rotation disk (step 121) →using the rotation device to bring the PE-RT pipe into rotation counterclockwise to a hot air device, to melt the connector region of the PE-RT pipe to a highly elastic state (step 122) →performing injection molding to form the connector: to use the rotation device to bring the PE-RT pipe into rotation counterclockwise to an injection mold, close the mold, to perform injection molding for the connector in the connector region (step 123) →popping out: open the mold, to use the rotation device to bring the PE-RT pipe into rotation counterclockwise to a pop out device, to pop out PE-RT pipeline (step 124).

In the present invention, the rotation disc is designed to have four working positions, while the rotation device includes a core, which is connected to the center of the rotation disc through the rotation axis. Along the periphery of the rotation disc is arranged counterclockwise with a hot air device, an injection mold, and a pop out device, while below the pop out device is disposed a material collection box. The rotation device will reach a next working position when it rotates 90 degrees countclockwise. In the present invention, the connector region is also an encapsulation region, injection molding of the connector is performed at both ends of the PE-RT pipe. In other words, encapsulation is performed at both ends of the PE-RT pipe, to form a PE-RT pipeline.

In the present embodiment, the extrusion speed of the extruder is 1-10 mm/s. After a connector region is melted, start injection molding for the connector region to form a connector within 2 seconds. The period of injection molding for the connector is 15-40 seconds, while entire period for ejection molding the PE-RT pipeline is 18-50 seconds.

In the present embodiment, the connector regions are at both ends of the PE-RT pipe, while the length of the connector region is 10 mm-50 mm.

In the present embodiment, the hot air temperature of the hot air device is controlled at 200° C.-400° C.

In the present embodiment, both the flux and temperature of the air flow produced by the hot air device can be adjusted.

In the explosion pressure test, the PE-RT pipeline is able to withstand pressure of 700 psi for 1 minute, without causing water leakage, while it can still function normally. In an extremely high temperature test, the PE-RT pipeline is infused with water of dynamic pressure 125 psi at a temperature of 90° C., and after 30 minutes, no water leakage occurs, while it can still function normally. In a sporadic impact test, hot and cold water are used (hot water temperature 60° C., cold water is at room temperature). For this purpose, an electromagnetic valve switch is utilized (opened for 2 seconds, and closed for 2 seconds), so that the PE-RT pipeline will be exerted pressure 180 psi for 3000 times, such that after the test, no water leakage occurs, while it can still function normally. In a drawing force test, after the PE-RT pipeline is exerted a drawing force 150 LBF for one minute, it is tested under a pressure of 250 psi for 5 minutes, at this time, it can still function normally; even when the pressure is increased to 350 psi, the PE-RT pipeline is still able to function normally.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A method of molding PE-RT (polyethylene of raised temperature resistance) pipeline, comprising processes of: extrusion molding a PE-RT pipe; and injection molding a connector of the PE-RT pipe; wherein, the process of extrusion molding the PE-RT pipe includes following steps: preparing material; using an extruder to extrude into mold a PE-RT pipe; performing vacuum diameter fixing; drawing and transporting; cutting the PE-RT pipe into predetermined size to enter a positioning region; while the process of ejection molding the connector of the PE-RT pipe includes following steps: positioning, to put the PE-RT pipe around and through a core of a rotation device on a rotation disk; using the rotation device to bring the PE-RT pipe into rotation counterclockwise to a hot air device, to melt the connector region of the PE-RT pipe to a high-elastic state; performing injection molding to form the connector, to use the rotation device to bring the PE-RT pipe into rotation counterclockwise to an injection mold, then close the mold, to perform injection molding for the connector region of the connector; and popping out, to open the mold, and to use the rotation device to bring the PE-RT pipe into rotation counterclockwise to a pop-out device to pop out a PE-RT pipeline.

2. The method of molding PE-RT pipeline as claimed in claim 1, wherein an extrusion speed of the extruder is 1-10 mm/s, and after the connector region is melted, start injection molding for the connector region to form a connector within 2 seconds, a period of injection molding for the connector is 15-40 seconds, while an entire period for ejection molding the PE-RT pipeline is 18-50 seconds.

3. The method of molding PE-RT pipeline as claimed in claim 1, wherein the connector regions are at both ends of the PE-RT pipe, while length of the connector region is 10 mm-50 mm.

4. The method of molding PE-RT pipeline as claimed in claim 1, wherein hot air temperature of the hot air device is controlled at 200° C., -400° C.

5. The method of molding PE-RT pipeline as claimed in claim 1, wherein flux and temperature of an air flow produced by the hot air device are adjusted to achieve the PE-RT pipeline as required.
